(19) United States
(12) Patent Application Publication
(10) Pub. No.: US 2007/0078772 A1
(43) Pub. Date: Apr. 5, 2007

(54) SYSTEM AND METHOD FOR THE DISTRIBUTION OF DIGITAL CONTENT

(75) Inventor: Ryan Dadd, New York, NY (US)

Correspondence Address: DICKSTEIN SHAPIRO LLP, 1177 AVENUE OF THE AMERICAS (6TH AVENUE), NEW YORK, NY, 10036-2714, US

(73) Assignee: BurnLounge, Inc., New York, NY (US)

(21) Appl. No.: 11/532,758

(22) Filed: Sep. 18, 2006

Related U.S. Application Data
(60) Provisional application No. 60/718,058, filed on Sep. 16, 2005.

(51) Int. Cl. G06Q 99/00

(52) U.S. Cl. 705/52

(57) ABSTRACT

A system and method for The present invention is a system and method for the distribution of digital content over a network, such as the Internet. The present invention distributes digital content though a virtually unlimited number of customizable websites. Although managed and operated by a central operator, each of the websites through which customers can purchase digital content is customized and controlled by independent affiliates. In a preferred embodiment, the websites are hosted by the operator of the system on centralized web application servers. The operator provides the independent affiliates with the tools necessary to individualize and customize their own websites. The operator of the site further maintains centralized digital content servers that securely store and allow distribution of the digital content through the customized websites.

### CROSS REFERENCE TO RELATED APPLICATIONS

This application claims priority to U.S. Provisional Application No. 60/718,058, filed on Sep. 16, 2005 the entirety of which is incorporated herein by reference.

### FIELD OF THE INVENTION

The present invention generally relates to systems and methods for distributing digital content, and more particularly to systems and methods for secure and controlled distribution of digital content using a plurality of retailer operated online storefronts.

### BACKGROUND OF THE INVENTION

The music industry has seen the writing on the wall. The future of music involves the Internet. Several of the major record labels and retailers, anticipating the coming revolution, have begun shedding their traditional terrestrial manufacturing and distribution facilities. The shift from traditional packaged goods has had yet a further impact. Declining sales have forced several major traditional retailers into closing or bankruptcy. This shrinking shelf space and the rise of retailers using music as a “loss-leader” have hastened the industry's need for an answer, but no one seems to be able to say exactly where on the Internet this future is to be found.

The meteoric growth of services such as Friendster® has shown the power of the Internet as a social network. Even the original Napster® was never so much a service as it was a community, held together by the power of music and the ease of sharing musical experiences over the Internet.

For years, industry watchers have seen a dramatic shift occurring. Yet, the major record companies have stumbled when confronted with the changes. The major record companies have sunk billions into CD factories and distribution warehouses. With the inevitability of digital music downloads rendering their “brick-and mortar” systems obsolete, the major record companies begrudgingly began to invest in new technologies. However, confronted with the realization that they could lose billions of dollars in their terrestrial distribution and manufacturing mechanisms, coupled with fewer retail options; the music industry has hit the proverbial “brick” wall. None of the current solutions seem to provide the industry with the geometric growth necessary to completely abandon the old way of doing things. Everyone seems to be asking the same question, “How can we take advantage of the digital music revolution without spending tens of millions reinventing the wheel?”

For years record companies have relied on networks of music fans (known as street teams) to promote their artists. Street teams are small groups of aggressive music fans that are mobilized to promote artists to their local communities. These street teams are generally compensated with t-shirts, hats or concert tickets. This concept of grassroots marketing has proven to have a positive but limited effect. Ultimately, it is difficult to consistently motivate people when all they may receive in return is a t-shirt.

One popular system and method for the distribution of digital musical content is the iTunes® service offered by Apple®. When iTunes® launched in 2003, the market for legal digital downloadable music was very small. iTunes® embarked on an a massive marketing campaign aimed at educating consumers about the ease of legal downloads, thus firing the first shots in the digital music revolution. Since then, advertisements for iTunes® and iPod® (Apple's digital music player) have begun appearing on virtually every billboard, radio and television station in America. This enormous effort has cost Apple® an estimated $35 million so far. The results have been impressive. Since it's launch, iTunes® has sold over a billion downloads. This success has prompted other major companies to throw their hat in to the digital music ring, such as Pepsi®, Coca-Cola®, Heineken®, Budweiser® and McDonalds®. Each of these corporations have initiated massive promotions of offering free music through various download services.

But digital music services like iTunes®, Napster®, SonyConnect®, RealRhapsody® Microsoft's® MSN® Music Service, and Virgin's® Download Store still have a problem. Because of limitations in their systems and methods for digital distribution of content, their cost of customer acquisition is exorbitant.

FIG. 1 illustrates a typical prior art digital content distribution system 12. Users wishing to search for and purchase digital content (e.g., music) employ their terminals 2 to connect to a network 10. User terminals 2 can comprise, for example, a personal computer, a personal digital assistant (e.g., a Blackberry®), a pager or other similar electronic communication device. Although network 10 can be a local area network (LAN) or wide area network (WAN), the most prevalent network 10 to which users connect is the Internet.

Through the Internet 10, users 2 connect to the home page 8 of a website of a digital content provider on system 12. The home page 8 and the other web pages (not specifically shown) constituting the content provider's website are supported on a web application server 6. As appreciated by those skilled in the art, the web application server 6 can be constituted by one or more physical devices. Furthermore, other devices such as load balancers can be used to control and balance the volume of users connecting to the web application server 6.

The web application server 6 is connected to a database server 4. The data server 4 stores the digital content offered by the digital content provider. As appreciated by those skilled in the art, the data server 4 can comprise one or more physical devices.

As conceptually illustrated in FIG. 1, the users 2 connect to a single home page 8 of the digital content provider. The single home page 8 is designed by, formatted by, customized by and controlled by the single digital content provider. How the digital content, products and other services are presented to the users 2 is completely controlled by the single entity. No other entities are allowed to control the presentation of the digital content to the users 2.

### SUMMARY OF THE INVENTION

The present invention is a system and method for the distribution of digital content over a network, such as the Internet. Unlike the warehouse sites such as iTunes® which present a single, monolithic, corporate designed and controlled user interface (storefront), the present invention is able to distribute digital content though a virtually unlimited number of customizable websites.

Although managed and operated by a central operator, each of the websites through which customers can purchase digital content is customized and controlled by independent affiliates. In a preferred embodiment, the websites are hosted by the operator of the system on centralized web application servers. The operator provides the independent affiliates with the tools necessary to individualize and customize their own websites. The operator of the site further maintains digital content distribution servers that securely store and allow distribution of the digital content through the customized websites.

Through the customized websites, the users are able to offer for sale the digital content, e.g. music, to customers visiting their websites. If a customer chooses to purchase a song, (movie, ring tone . . . ) the purchased content is downloaded from the centralized data servers to the user's device, e.g. personal computer. The digital content is securely transferred and preferably contains appropriate copy protection.

Each of the individualized website is further able to offer other services such as searching the centralized database for particular digital content (e.g., a particular song, a particular artist, a particular genre . . . ).

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates the system of the prior art;

FIG. 2 depicts the system of a first embodiment of the present invention;

FIG. 3 depicts the system of a second embodiment of the present invention; and

FIG. 4 illustrates an exemplary website storefront in accordance with the present invention.

### DETAILED DESCRIPTION OF THE INVENTION

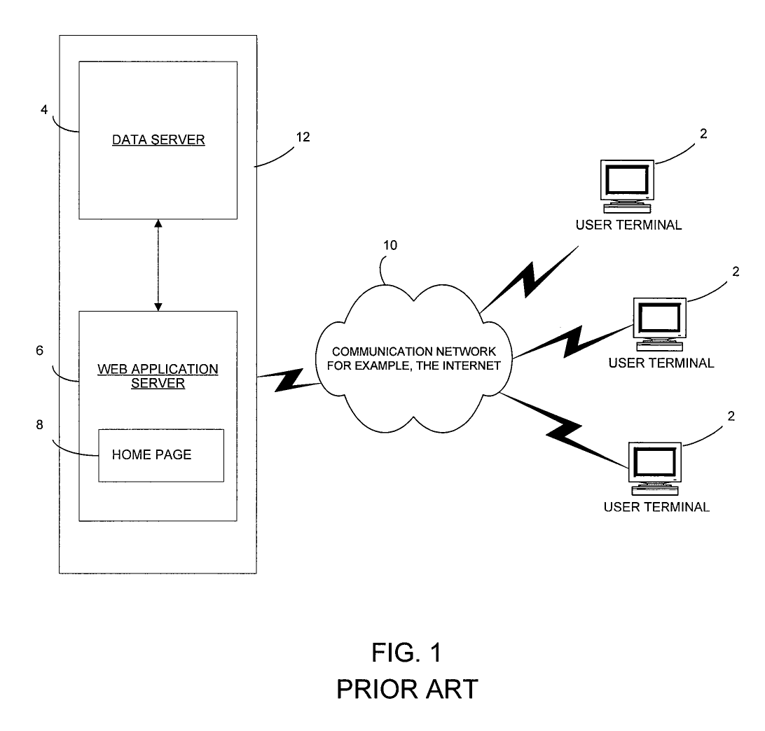

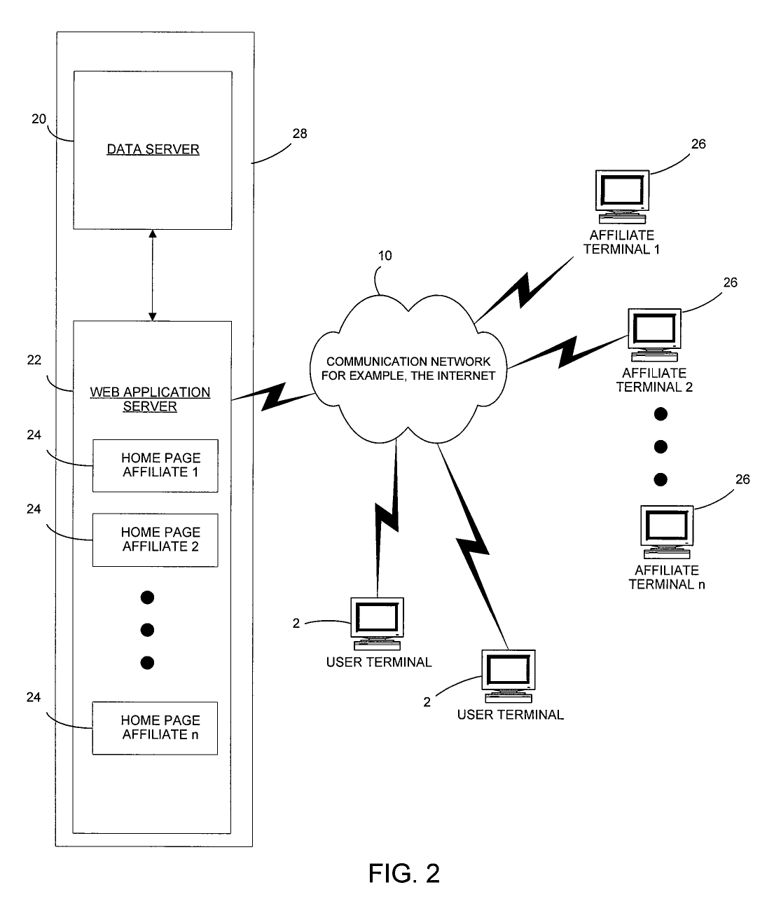

FIG. 2 illustrates a first embodiment of the present invention. Similar to the prior art system 12 of FIG. 1, system 28 of the present invention includes a data server 20. The data server 20 contains information about the digital content that is available for purchase by the users 2. In a preferred embodiment, data base server 2 runs a database application (sometimes referred to as DBMS—Data Base Management System). The DBMS holds the meta-data for the digital files and can also hold the digital content. The actual physical digital content may be stored outside the DBMS. The digital content could physically be stored on the database server 2 but in the preferred embodiment, the actual digital content it is stored on a RAID array. Further, the devices that store the actual physical digital content may maintained by a 3rd party, but under control of the operator of system 28. The web application server 22 of the present invention, though, is significantly different from the web application server 6 of the prior art.

As illustrated in this figure, the web application server 22 hosts a plurality of home pages 24. Again, as appreciated by those skilled in the art, other web pages are associated with each of home pages 24 thus constituting the complete websites. For a matter of convenience in the present description, reference will simply be made to home page 24 although those skilled in the art will appreciate that this description is applicable to each of the web pages constituting a full website.

Each of the plurality of home pages 24 are associated with a different affiliate. Affiliates use their own terminals 26 to communicate with system 28 in order to, among other operations, customize and individualize each of their own respective home pages 24. Like the home pages 8 of the prior art system 12, the home pages 24 of the affiliates 26 provide a user interface by which users 2 are able to search and purchase digital content. Unlike the home pages 8 of the prior art system 12, the home pages 24 of the affiliates are each controlled and customized by the respective affiliates 26.

In the preferred embodiment of the present invention, the primary digital content available for purchase through the affiliates' websites 24 is music. As further described below, each of the affiliates 26 are able to customize their own website 24 in order to highlight the favorite music of the affiliate. As appreciated by those skilled in the art, any other type of digital content can be sold using the present invention such as movies, music videos, cell phone ring tones and the like. Additionally, traditional merchandise such as hats, tee shirts, shoes, electronic equipment can be purchased using system 28 and shipped to the customer via traditional terrestrial distribution channels.

In the business model of the present invention, for each piece of music sold to a user 2 by an affiliate 26 through website 24, the affiliate 26 receives a percentage of the purchase price of the item or a flat fee for each item sold. In the prior art system 12 as illustrated in FIG. 1, the owner/operator of system 12 retains all of the profits from the sale of items through system 12 (naturally, after payment of the requisite royalties to the record label/artist). As can now be appreciated by a comparison between system 12 of the prior art and system 28 of the present invention, each of the affiliates in the present invention has an incredible incentive to market and attract customers 2 to system 28.

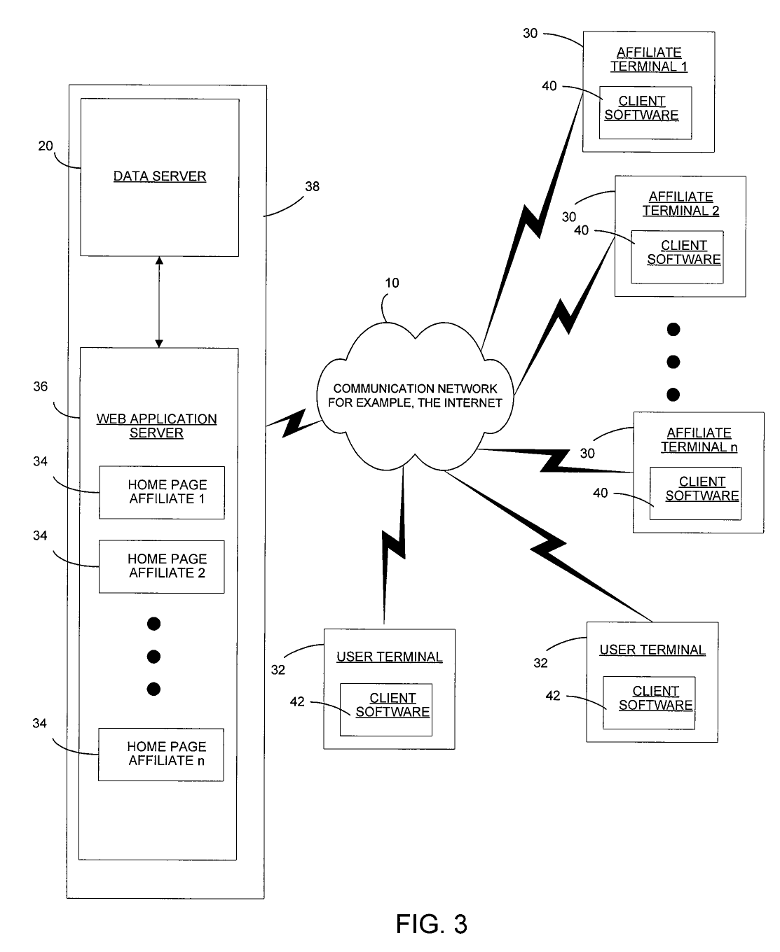

In the embodiment of FIG. 2, affiliates 26 and customers 2 simply use their Internet browsers to connect and communicate with system 28. FIG. 3 illustrates a second embodiment of the present invention using a client/server model. As seen in this Figure, system 38 of the client/sever embodiment of the present invention includes a data server 20 and web application server 36. The web application server 36 hosts the web pages 34 of each of the affiliates 30. The significant difference between the embodiments of FIGS. 2 and 3 is that client software 40 and 42 respectively operates on the workstations 30 and 32 of the affiliates 30 and users 32 respectively. As further described below, the client software 40, 42 allows additional functionality that is not available in the browser based model of FIG. 2.

In a preferred embodiment, the client software 40, 42 is downloaded to an affiliate or customer workstation 30, 32 from one of the affiliate websites 34. When a user has 32 has completed the download and installation processes, the customer registers with the system 38 via the affiliate web page 34 from which the user 32 downloaded the client 42. The registration process preferably includes obtaining credit card or other payment information by which a customer 32 intends on using to pay for purchases made through affiliate's web page 34.

As appreciated by those skilled in the art, client software 40, 42 operates in cooperation with data server 20, web server 36, and web pages 34 in order to provide the functionality described below when the user 32 is connected to system 38 (online operation). In addition, client software 40, 42 can operate in an offline mode using data and digital content stored on the affiliate 30 or customer 32 devices.

The client provided interface is broken down into eight distinct areas: Client Menu Bar; Music and Video Player; Information Bar; Navigation Menu; Checkout Bar; Download Manager Bar; and the Main Staging Area.

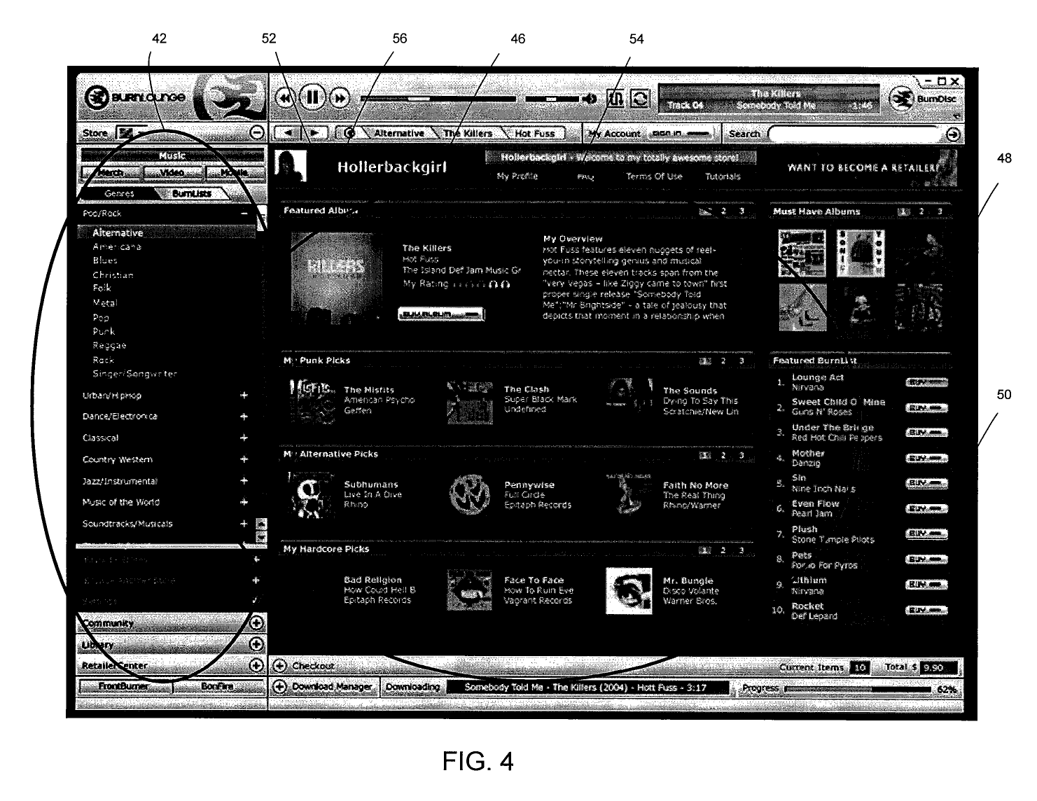

The Client Menu Bar is a thin bar at the very top of the user interface screen. Below the Client Menu Bar is the Music Player and below the Music Player is the Information Bar. To the left of the Information Bar is the Navigation Menu that plays host to a number of expandable/collapsible menus. A large area to the right of the Navigation Menu is the Main Staging Area (the Main Staging Area can be seen in FIG. 4, element 46). Below the Main Staging is the Checkout Bar. Below the Checkout Bar is the Download Manager Bar. Below the Download Manager Bar is the Burnalikes Bar.

In a present embodiment, client software 40, 42 operates with Window Media player 10 and Windows XP or higher operating system. As briefly described above client software 40, 42 interacts with system 38 through the Internet 10, however all the web-independent features in the client software 40, 42 are functional if a user 32 or affiliate 30 is on or offline. The client software 42 for a customer is substantially similar to the client software 40 for an affiliate. As further described below, the client 40 for an affiliate 30 has additional functionality that enables the affiliate to organize, configure, customize and monitor the affiliate's web site 34.

As further described below, users 2 in the embodiment of FIG. 2 are not able to access certain functionality (e.g., Community, and Store, see below) that is only be available through the use of client software 42.

Client Menu Bar has several submenus associated therewith such as: a File menu; a Rate-It menu; a Burn list menu; a Control menu; a Settings menu; a Community menu; a Library menu and a Favorite Store menu.

The File option allows the user to create a new list of songs that user wishes to group together (a BurnList). The user can also add new file (song, video, ringtone) to the user's library that is stored on the user's device 32.

The Rate-it option, that is active when a user is listening to a track (a song), allows the user to rate the track. The user's rating is stored in the user's library in association with the particular track.

The BurnList option allows the user to write (burn) a user created Burnlist to disk. The Controls option provides the user with several controls over the operation of the music or video player, such as: Play (plays the track or video); Stop (stops the music or video); Pause (pauses the music or video); Next Song (moves forward to the next song in the library or playlist); Previous Song (moves backward to the previous song in the library or playlist); Next Chapter (moves forward to the next chapter in a DVD movie); Previous Chapter (moves backward to the next chapter in a DVD movie); Shuffle (plays all songs in the library or playlist in a random order); Repeat Off (turns repeat off); Repeat All (repeats all songs in library or playlist); Repeat Once (repeats the current song playing once); Volume Up (turns up the volume on the device); Volume Down (turns the volume down); Mute (mutes the sound).

The Settings option from the Client Menu bar displays the following Options: Store; Parental Controls; Account Information; Billing Information; Preferences; and Order History. Clicking on any of these options will launch that particular option in Main Staging Area.

The Community option from the Client Menu bar displays the following options: Profile Settings; View Blocked Buddies; Emessage Settings; Time Settings; Bulletin Settings; and Blog Settings. Again, clicking on any of these options will launch that particular option in Main Staging Area.

The Favorite Stores options from the Client Menu bar allows the user to creates a link to the store 34 in which the user is currently browsing.

The Library options from the Client Menu bar launches a windows folder browsing window in which the user can choose the default folder in which user wants all downloads to be stored. The Library options window further allows the user choose their settings for the Media Player. In a presently preferred embodiment, the window provides the same options that a user would see if in Window Media Player 10 Player Options. The Library option is further able to launch a Files Types Options Window. In a presently preferred embodiment all file types currently available in Windows Media Player 10 are supported by the present invention, as well as FLAC and WMAL (WMA lossless format). The default files types currently preferred are WMA, WAV, MP3, and WMV.

The Music and Video Player Area contains the standard music player for the client 40, 42. If the user chooses to play a video, the default video media player window will pop up to serve as the video display screen.

The Information Bar Area displays various information to the user. If the user is online (i.e., connected to system 38 through the Internet 10) and is currently browsing in the store 34 of a particular affiliate, the Information Bar Area displays various control information. A Back Arrow button in the Information Display Area takes the user back to the previous store 34 page that the user had viewed. A Forward Arrow button takes user to the forward page in the store 34. Genre, Artist, and Album Tabs in the Information Bar Area displays Genre, Artist and Album Information when the user is browsing in the store 34. A My Account Sign In button opens an Account Log-in Pop up window that allows the user to log into the user's account in system 38. The Information Bar Area also provides functionality for the user to search the digital content stored on data server 20.

If the user is using the Community functionality of the present invention, the Information Bar Area will again provide the user with certain options. A Back Arrow button takes the user to the previous community page that the user viewed. A Forward Arrow button takes user to the forward one page in the Community.

If the user 30, 32 is offline (i.e., not connected to system 38) all of the Library options described above are available. The Store, Community, and Tools options cannot be accessed offline

The Checkout Bar area of the user interface of client 40, 42 provides the functionality for allowing the user to purchase digital content or other merchandise from the store 34 of an affiliate. The functionality of the checkout bar is standard and well known to those skilled in the art of Internet commerce.

The Download Manager Bar area of the user interface of client 40, 42 provides the user with capability of managing his or her downloads of digital content from system 38. If the user is online, when clicked, the Download Manager Bar expands a Download Manager Screen in the Main Staging Area. The Download Manager Screen is divided into 2 sections: a Navigation Section and a Main Display Area. If the user has one or more items to download, the Navigation Section displays: “Items Ready To Download.”

If the user's item to be downloaded is an album, the user is able to select an Album Art button that displays an Item Detail Page in the main display area of the download screen. The Item Detail Page displays all songs associated with the album. The display includes the song title, the artist's name, the album's name, the genre and the label.

If the user selects the download button, all song files associated with selected album are download to the default folder previously selected by the user (see above). Alternatively, the user can choose another location in which to store the music files.

If the user's item to be downloaded is a song, selecting the song name displays the Item Detail Page in the Main Display Area of the Download Screen. The Item Detail Page displays the song title, the artist's name and the album name. If the user selects the download button, the song file is download to the default folder previously selected by the user (see above). Alternatively, the user can choose another location in which to store the song file.

If the user's item to be downloaded is a BurnList (see above), selecting the Burnlist name displays the Item Detail Page in the Main Display Area of the Download Screen. The Item Detail Page displays all songs associated including the song titles, the artists' names and the albums' names. If the user selects the download button, all the song files associated with selected BurnList are download to the default folder previously selected by the user (see above). Alternatively, the user can choose another location in which to store the music files.

If the user is offline, the functionality associated with the Download Manager is not available

The Navigation Menu allows the user various ways to navigate the client software 40, 42 options as well as the system 38. If the user is online, the Navigation Menu displays: a Store Menu Selection Bar; a Community Menu Selection Bar; a Library Menu Selection bar; a Sell Music Quick Link; and a BonFire Quick Link

Both affiliates 30 and customers 32 have the ability to set up store 34 settings. These settings determine how the client 40, 42 behaves when a user 30, 32 is navigating in a store 34. Affiliates 30 are able to filter particular genres that the affiliate 30 does not want to be displayed in their store 34. Affiliates 34 are also able to decide if their store 34 will sell albums that contain explicit content. Customers 32 have access to parental controls that allow for filtering of explicit content in stores 34 and allow them to block stores from being viewed.

If an affiliate 30 has elected to filter one or more genres, the filtered genre navigation bar in the client 40, 42 is no longer functional. If a user 32, 30 attempts to select the filtered genre, no changes are produced. If an affiliate 30 has selected to filter explicit content, then all albums that are marked explicit content cannot and are not be displayed in the affiliate's store 34. If a customer 32 has chosen to filter explicit content, albums that contained on data server 20 that are marked as explicit content are not displayed while that particular user 32 is browsing the store 34. If a customer 32 has chosen to block particular store or stores 34, when the particular user 32 has logged in and attempts to visit a blocked store 34, the store 34 is not opened and the user 32 is prompted the he/she is not allowed to view that store 34.

From the Navigation Menu, the Store Menu Selection Bar provides the user 30, 32 with several options with respect to different stores 34. One of the options opens the user's default Music store home page 34 in the Main Staging Area and reveals the Store Navigation Section in the Navigation Menu Area.

The Store Navigation Section is broken down into several different zones: Store Type Selection Zone; a Type Store Navigation Zone; and a Store Options Zone. The Store Type Selection Zone allows the user to select the type of store 34 he/she want to visit including Music, Merchandise, Mobile and Video. If the user selects Music, the user's default Music Store homepage 34 is opened and the Music Type Store Navigation Zone is revealed. Under the Music Store Navigation Zone is a Genre Navigational Tab. Selecting the Genre Navigational Tab reveals the genres of the music available through the store 34 such as: Rock/Pop; Urban/Hip Hop; Dance/Electronic; Classical; Country Western; Jazz/International; Music of the World; Standards/Vocal; Christian; Comedy/Spoken Word; Children's; Books; and Sound Tracks. Selecting any of these genres will bring up a list of the songs and/or album available in that genre in the Main Staging Area.

The BurnList Navigational Tab allows the user 30, 32 to view a submenu of all BurnLists available to the user including: Celebrity BurnLists; My BurnLists; or My Friends BurnLists.

If the user selects the Merchandise button in the Type Store Navigation Zone, the user's 30, 32 Merchandise Store homepage 34 is opened gives the user 30, 32 the following merchandise options: Gear Merchandise (e.g., T-shirts, Hoodies, Shoes/Footwear, Hats/Caps, Accessories); Electronics Merchandise (e.g., Music Players, Phones, Speakers/Headphones, DVD Players

If the user 30, 32 selects the Video button in the Type Store Navigation Zone, the navigation is the same as for a Music store 34 as described above, except for videos rather than music. Any genre that is filtered (as described above) will not be active.

If the user 30, 32 selects the Store Options Zone, the following options are displayed: Favorite Stores Bar; Browse Another Store Bar; Settings Bar. When a user 30, 32 selects Favorite Stores, the user is provided with a list of his/her favorite stores (previously stored). From the Settings Sub Menu the user is able to add the current store 34 being browsed in the user's Favorite Store list.

If the user 30, 32 selects the Browse Another Store option, system 38 allows the user to search for another store 34 by store name, by place, by zip code or by music type.

The Settings option has 5 different sections: Account Information; Store Settings; Billing and Shipping Information; Library; and BurnRewards. The Account Information Section displays: User First Name/Last Name; User Email Address; User Birthday [mm/dd/yyyy]; User Phone Number and the ability to edit any of user's account information. The Store Settings option allows the user to enter and edit the user's options with respect to the system's 38 stores 34 such as: Receive Marketing Emails; Checkout Settings; and Email Format. The Billing and Shipping Information Section allows the user to enter and edit the user's options with respect to the system's 38 billing system with respect to the user such as: Credit Card; and Billing Address. The Library Section displays to the user a summary of digital content that have or have not been downloaded. The BurnRewards Section displays a summary of the rewards that an affiliate 30 has received for the sale of digital content, merchandise or other items that have sold through the affiliate's store 34.

An important aspect of a system 38 according to the present invention is the ability of patents to control what their children can view and download using the system. System 38 (and in conjunction clients 40, 420 accordingly have a Parental Controls Screen. The Parental Controls Screen is broken down into 2 areas: Parental Controls Submission Area and Parental Control Management Area

The Parental Control Submission Area allows parent to control what their children will view when browsing for music. Specifically, the parent user 30, 32 is provided a tool for filtering explicit content. This filter allows the children to browse stores without seeing any content that has explicit content. Entire stores can be blocked. As the child is registered with the system 38 through the parent's account, the parent simply has to enter the child's system 38 username and password and inform the system 38 of the desire to filter explicit content. Thereafter system 38 filters all explicit content when the validated child's username is browsing any store The child is further blocked from visiting the store name that the parent has blocked. The Parental Control Management Area allows parents to manage the controls described above.

One of the significant features of the present invention is the incorporation of the concept of a community into system 38 and stores 34. Most significantly, the system 38 of the present invention enables users 30, 32 to use their own familiar Instant Messaging (IM) software in system 38. This is true of all of the major IM systems including AIM, MSN, Yahoo Instant Messenger, and ICQ. The user's screen names from all of these different IM systems is supported by system 38.

Other community building features are available through the Community Navigation feature. The Community Store Menu Selection bar displays the options for: opening the user's Buddies Page in the Main Staging Area; a Buddies Navigation Bar; a Self Navigation Bar; an Emessage Navigation Bar; a Time Navigation Bar; a Bulletins Navigation Bar; a Blogs Navigation Bar; and an Invitations Navigation Bar.

The Buddies Navigation Bar displays: Friends; Artists; All Buddies; Online Now; Buddy Settings; and Buddy Song Settings. The system 38 allows each user 30, 32 to associate a song with the user's username. Users can thus play the song associated with each of the Buddies.

The Self Navigation Bar allows the user 30, 32 to edit the user's system 38 community profile. The user's 30, 32 profile include biographical information (if the user desires to supply such information) and a user's favorite song. In this sense, system 38 provides a community somewhat along the lines of the popular web site myspace.com®.

Further to goal of community building, system 38 allows the creation and transmission of email messages. The Emessage Navigation Bar allows the user to view the user's 30, 32 Inbox, create and send new email messages; and view sent email.

The Time Navigation Bar provides the user 30, 32 with a calendar function. As with most communities, there are events that bring the communities together, such as a concert in the music community and these events need to be calendared. The Time Navigation Bar provides an alarm function and both work and personal calendars. The user's 30, 32 calendars can be searched.

The Bulletin Navigation Bar allows the user 30, 32 to view bulletins issued by system 38, other users 30, 32, artists, and/or the user's Buddies. Again, with any community, communication among members is a critical necessity to keep the community informed, vital, growing and interested.

As know to those skilled in the art, blogs are a popular form of communication in all online communities. The Blogs Navigation Bar allows users 30, 32 to monitor Blogs in which the user is interested. Furthermore, this tool allows the user 30, 32 to create and maintain their own Blogs.

In keeping with traditional terrestrial communities, the online community of system 38 provides the capability to provide and manage invitations to each other.

An important aspect of the client software 40, 42 is the ability for a user 30, 32 to manage and navigate the user's personal library of downloaded digital content. The Library Store Sub Menu Selection bar provides the user 30, 32 with various options with respect to the user's Library

Selecting a Library name opens the users entire Library in a Music Display Screen in the Main Staging Area. The Music Display Screen displays the user's Library with the following information regarding the digital content in a list form: Song Title; Time; Artist; Album; Genre; Rating; Play Count; and Last Played. Clicking on the Song Title column organizes the user's library/playlist by song title in alphabetical order (a-z). Clicking the Time column organizes user's library/playlist by the length of each track (shortest to longest). Clicking the Artist column organizes the user's library/playlist by grouping tracks by artist name and organizes each group in alphabetical order (a-z). Clicking the Album column organizes the user's library/playlist by grouping tracks by Album name and organizes each group in alphabetical order (a-z). Clicking the Genre column organizes the user's library/playlist by grouping tracks by Genre name and organizes each group in alphabetical order (a-z). Clicking the Rating column organizes the user's library/playlist by grouping tracks by user's own rating (see above) and organizes each group from highest to lowest Clicking the Play Count column organizes the user's library/playlist by grouping tracks by the numbers of times a song has been played by the user 30, 32 and organizes each group from highest to lowest. Clicking the Last Played column organizes the user's library/playlist by grouping tracks by the date the user 30, 32 last played a particular song and organizes each group from most recent date to least recent date.

Although substantially similar, there are differences between the client 42 for a customer user 32 and the client software 40 for an affiliate. The Navigation Menu for an affiliate 30 displays: a Store Menu Selection Bar; a Community Menu Selection Bar; a Library Menu Selection Bar; and a Resource Center Menu Selection Bar. The Store Navigation, Community Navigation and the Library Navigation for the affiliate client 40 is the same as the customer client 42.

Unlike the customer client 42, the affiliate client 40 provides a Retailer Center Navigation Tools Menu. One of the Tools available to an affiliate 30 is a store activity summary page. This summary includes information regarding: Total Earnings; Total Withdrawals; Total Purchases; Total Transfers; Total Account Funding; Total Adjustments; Balance; and Pending Earnings.

A significant aspect of the present invention is the ability of an affiliate 30 to customize his or her own web page 34. FIG. 4 illustrates an affiliate's customized home page 34 that acts as the affiliate's store. As used herein the term “store” will be used to denote the affiliate's web page 34. Each store 34 is essentially broken down into two “departments”. A General Music Department 42, which can be browsed by genres, is where a user 32 can shop for specific albums, artists and tracks like in a brick and mortar record store. The second “department” 44, 46, 48, 50 and 52 is where the affiliate can highlight his or her own favorite music (or music the affiliate deems likely to sell) and can features BurnLists. BurnLists are collections of songs that an affiliate 30 groups together for sale, thus creating their own albums for purchase by any customer 32. Burnlists aren't broken down by genre, but by category.

The video portion of the store 34 (not shown in FIG. 4) is substantially similar to the music store. The video portion of the store 34 is also broken down by genre. Customers 32 can use these genres to browse for videos that he/she wishes to purchase. The affiliate 30 can highlight his or her favorite videos in the video portion of the store 34. It is not currently envisioned that Burnlists would be created for full length videos, but they can be created for the shorter length music videos.

The store 34 can also feature a general department for products for mobile devices (e.g., cellphones) such as ringtones or wallpapers. Similarly, the affiliate 30 can feature his or her favorite mobile products in the customized portion of the store 34.

In a preferred embodiment, an Album Detail Page is provided on a store 34 and is like going to a bricks and mortar record store and picking up the CD and turning it over to view the tracks. The Album Detail Page would be brought up in the Main Staging Area 46 as shown in FIG. 4. On this page a user can decide to purchase the whole album or just individual tracks. This page will also provide the user with more information about that album. BurnList pages, created by the affiliate 30 are formatted in the same way as the Album Detail Page.

The general configuration for a store homepage 34 and genre/sub genre (music and video) pages are the same. Each of these page types contain a featured album area 52, must have areas 48, secondary display area or areas 54 and a featured BurnList area 50.

As appreciated by those skilled in the art, several of the features and functionality of the present invention are enabled through software. For the convenience of discussion, the software required to enable a particular functionality will be denoted as a module. Those skilled in the programming arts will understand from the description provided herein the software instructions required to construct a particular module. One these modules is denoted as the store 34 customization module.

All stores 34 have the ability to be customized by an affiliate 30. The following are specifically the areas of customization that are available to the affiliate 30 in the present invention: the affiliate 30 has the ability to customize their store 34 layout; affiliates 30 have the ability to choose from a variety of different background colors and themes. In a preferred embodiment of the present invention, the themes are provided and controlled by the owner and/operator of system 38; affiliates 30 have the ability to remove product displays areas and replace that display area with advertisements; affiliates 30 have the ability to chose the music, merchandise, mobile and video content he/she wishes to display on the store homepage 34; affiliates 30 have the ability to filter genres; and affiliates 30 have the ability to filter explicit content.

In a preferred embodiment, each store 34 supports at least ten languages and supports multiple currencies. In this preferred embodiment standard item price are in US dollars, however dollars must be converted to the currency type of the store 34. The centralized operator of system 38 may allow the stores to sell digital music content in a variety of different formats and bit rates, those formats including but not limited to WMA, MP3 and FLAC.

The store homepage 34 is launched when the client 40, 42 is first opened by the user 32, 30 or a user 30, 32 navigates back to the store 34 while using other functionalities within the client 40, 42. The store homepage 34 is divided into five different areas: the Affiliate Banner 56; the Featured Products Display Bin 52; the Secondary Products Display Area 54; the Must Have Products Display Bin 48; and Featured BurnList Display 50.

The Affiliate Banner 56 displays: the afilliate's 30 Logos; a Community Buddy Icon; an art banner; an affiliate 30 Message Box containing a message from the affiliate's; My Profile Box that contains a personal profile of the affiliate 30; and a Help Box

The Featured Products Display Bin 52 displays: a Featured Product Title Bar; Featured Product Art; Featured Product Description; and Featured Product Overview.

The Featured Product Title Bar is the area in which a list of the titles of the content (e.g., songs, albums, videos) selected by the affiliate 30 is presented. In the Featured Product Art section, if the product is an album, the Album Art is displayed. If the product is a video, the Featured Product Art displays the Video Art. If the product is album, the Featured Product Description displays the Artist's Name, the Album Name, the Release Date, the Label Name, the Genre Type, the Price and a Buy Album button. If the product is a music video, the Featured Product Description displays the Artist's Name, the Song Name, the Price and a Buy Video button. The Featured Product Overview section allows the affiliate 30 to write and store a personalized description of the products that he/she has chosen to highlight in the Featured Products section.

In addition to the featured product section, a preferred embodiment of the present invention, the affiliate 30 has an additional area on the home page 34, a Secondary Product Display Area 54 in which to feature further products.

As described above, an affiliate 30 is capable of creating his or her own Burnlists that comprise a collection of songs grouped by the affiliate 30. For example, if the affiliate 30 is a DJ at a club, the DJ has collections of songs that he or she plays at the club that con be combined into a Dancemix Burnlist. The affiliate's 30 home page 34 has an area known a Featured BurnList 50 in which the affiliate 30 can feature his or her own Burnlists.

In the General Department portion 42 of a store 34, a Featured Album Section displays the albums featured by the owner/operator of system 38. The information contained in the Featured Album section is substantially the same as the information describes above as being displayed in the affiliate 30 customized featured product section. Similarly, the General Department section contains a Secondary Album section.

The present invention provides a technical solution to several technical problems. First, the prior art warehouses of digital content make it difficult for users to search and find music that is in line with their tastes. In contrast, the present invention, with the plurality of web sites created by a plurality of different affiliates allows a user to much more quickly and easily find an affiliate featuring the types of music in which the user is interested. Further, the present invention integrates many of the technical community features that users presently have to separately subscribe to, such as instant messaging, blogs and event calendars. By integrating these separate features into a single integrated system the technical demands on users is significantly decreased.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

We claim:

1. A system for the distribution of digital content comprising:
a data server storing the digital content, the digital content being publicly accessible for purchase and download;
a web application server coupled to the data server; and
a plurality of sets of web pages hosted on the web application server, at least one web page in each of the plurality of sets of web pages being customized by a respective one of a plurality of users, the at least one web page enabling the purchase and downloading of the digital content from the data server by other users.

2. The system of claim 1, wherein the digital content comprise music files.

3. The system of claim 2, wherein the at least one customized web page comprises a listing of music files selected by the respective user.

4. The system of claim 1, further comprising a customization module whereby the respective user can select the music files from the music files stored on the data server.

5. The system of claim 4, wherein the customization module allows the respective user to group music files as a set for downloading.

6. The system of claim 1, wherein a customer can navigate from the at least one customized web page of a first user to the at least one customized web page of a second user.

7. The system of claim 1, further comprising client software installed on a device of a user of the system.

8. The system of claim 1, further comprising an instant messaging module that enables users of the system to communicate with each other.

9. The system of claim 1, wherein the data server and the web application server are a single server.

10. The system of claim 1, wherein the data server further comprises a database management system and a storage device.

11. The system of claim 10, wherein the database management and the storage device reside on physically separate devices.

12. The system of claim 1, further comprising a blog module.

13. The system of claim 1, further comprising a library module that enables a user to organize downloaded digital content.

14. The system of claim 1, further comprising a search module that enables a user to search the data server for digital content.

15. A system for the distribution of digital content comprising:
a data base management system storing information regarding the digital content, the digital content being publicly accessible for purchase and download;
a web application coupled to the data base management system;
a plurality of sets of web pages supported by the web application, at least one web page in each of the plurality of sets of web pages being customized by a respective one of a plurality of users, the at least one web page enabling the purchase and downloading of the digital content from the data server by other users;
an instant messaging module that enables users of the system to communicate with each other;
a library module that enables a user to organize downloaded digital content; and
a search module that enables a user to search the data server for digital content.
